(19) United States
(12) Patent Application Publication
(10) Pub. No.: US 2021/0175996 A1
(43) Pub. Date: Jun. 10, 2021

(54) AIRCRAFT TRACKING SENSOR ARRANGEMENT, AND A DEVICE AND METHOD THEREOF

(71) Applicant: Sensire Oy, Joensuu (FI)

(72) Inventors: Ossi LAAKKONEN, Joensuu (FI); Aki HÄNNIKÄINEN, Joensuu (FI); Antti TOLONEN, Joensuu (FI)

(73) Assignee: Sensire Oy, Joensuu (FI)

(21) Appl. No.: 17/256,111

(22) PCT Filed: Jul. 1, 2019
(86) PCT No.: PCT/EP2019/067620

§ 371 Date: Dec. 24, 2020

Related U.S. Application Data
(60) Provisional application No. 62/691,776, filed on Jun. 29, 2018.

(51) Int. Cl. H04K 3/00; H04B 7/185; H04W 4/80

(52) U.S. Cl. CPC H04K 3/84; H04B 7/18506; H04K 2203/22; H04K 3/415; H04K 2203/18; H04W 4/80

(57) ABSTRACT

A gateway device for a sensor network comprising: communication means to communicate with an aircraft interface device or other communication means provided by aircraft, short-range wireless communication means for communicating with nodes via short range communication means, characterized in that the gateway device is arranged to receive flight status information from the aircraft interface device and to facilitate control of nodes in accordance with the flight status, such as that the gateway sends the nodes a command to disable all wireless transmission when the aircraft status is take off or landing, and a command to utilize only short-range wireless transmission means when the aircraft status is climb, cruise or descent. Corresponding arrangement and method are also presented.

### FIELD OF THE INVENTION

Generally the present invention relates to electronic devices and arrangements in logistics. Particularly, however not exclusively, the invention pertains to an electronic device, arrangement and method for tracking cargo in aircrafts.

### BACKGROUND

Air cargo is an essential part of intermodal transportation means. Tracking air cargo with sensors has been discussed in the prior art but the various different type of sensors rely on tracking during the cargo during the air transit without transmitting data during the flight.

Transmitting data during transit is however an important aspect of achieving real-time and intelligent tracking arrangements. Knowing the state of the cargo may not only be approached from the viewpoint of disposing or using the cargo once the whole transit is done but also to make certain actions during the transit if changes in the state of the cargo is detected.

Hence, being able to monitor cargo whatever the transportation means is and in sufficiently real-time is essential for managing the whole supply chain in an intelligent and preemptive manner. An aircraft may not be able to fix its cooling system, or repair cargo that has been shaken due to turbulence but a user detecting such failure in the supply chain and possible damage to the cargo may use the information to take action and quickly arrange for a replacement to be sent.

Prior art solutions have approached the air cargo tracking by not simply transmitting any data during flight, which is not a good thing since flights can often take for a multitude of hours. Further, the cargo tracking sensor arrangements have previously aimed at recognizing presence of an aircraft or movement pertaining to aircraft flight and facilitating control to simply disable wireless communication when inside or in vicinity of an aircraft.

### SUMMARY OF THE INVENTION

The objective of the embodiments of the present invention is to at least alleviate one or more of the aforementioned drawbacks evident in the prior art arrangements particularly in the context of aircraft cargo tracking arrangements. The objective is generally achieved with a gateway device and sensor network arrangement in accordance with the present invention.

The present invention offers an airplane cargo tracking arrangement that may communicate with the aircraft interface device and base wireless communication mode on the status of the flight.

In accordance with one aspect of the present invention a gateway device for a sensor network comprising:
communication means to communicate with an aircraft interface device or other communication means provided by aircraft,
short-range wireless communication means for communicating with nodes via short range communication means, characterized in that the gateway device is arranged to receive flight status information from the aircraft interface device and to facilitate control of nodes in accordance with the flight status, such as that the gateway sends the nodes a command to disable all wireless transmission when the aircraft status is takeoff or landing, and a command to utilize only short-range wireless transmission means when the aircraft status is climb, cruise or descent.

According to an exemplary embodiment of the present invention the short-range communication means comprise IEEE 802.11, IEEE 802.15.1 and/or such ISM/SRD band communication means.

According to an exemplary embodiment of the present invention the communication means to communicate with the aircraft communication means comprise a USB or Ethernet connection.

According to an exemplary embodiment of the present invention broadband connection for sending measurement data received from the nodes via the aircraft interface device.

According to an exemplary embodiment of the present invention the device comprises a narrowband connection for sending alerts associable with the gateway device or the nodes via the aircraft interface device.

In accordance with one aspect of the present invention an arrangement for controlling node communications in an aircraft:
a gateway device arranged to receive flight status information from an aircraft interface device, the gateway further comprising means to facilitate wireless short-range communication,
at least one node comprising at least wireless short-range communication means,
the gateway being arranged to facilitate control of the nodes in accordance with the flight status, such as that the gateway sends the nodes a command to disable all wireless transmission when the aircraft status is takeoff or landing, and a command to utilize only short-range wireless transmission means when the aircraft status is climb, cruise or descent.

According to an exemplary embodiment of the present invention a node comprises long-range wireless communication means, which are controlled in accordance with the flight status.

According to an exemplary embodiment of the present invention the nodes comprise ambient variable, movement and/or orientation detection means.

According to an exemplary embodiment of the present invention the detection means are used to determine flight status at a node and wherein the node disables long-range wireless transmissions when takeoff, landing, climbing, cruising or descending flight status is determined.

According to an exemplary embodiment of the present invention the gateway device facilitates command of the long-range wireless communication means of the nodes such that gateway sends the nodes a command to disable long-range wireless transmission when the aircraft status is takeoff, landing, climb, cruise or descent.

According to an exemplary embodiment of the present invention comprising a remote server or a cloud service for receiving data from the gateway device.

According to an exemplary embodiment of the present invention the remote entity or cloud service and the gateway device are connected via a broadband or narrowband connection in accordance with the flight status.

According to an exemplary embodiment of the present invention the remote entity or cloud service is arranged to for receiving alerts or data from the gateway device wherein the data is measurement data of an aircraft cargo.

According to an exemplary embodiment of the present invention the nodes are arranged to send alerts or measurement data of an aircraft cargo to the remote entity or cloud service via long-range communication means.

In accordance with one aspect of the present invention a method for controlling nodes in a wireless sensor network comprising,
receiving flight status information from an aircraft interface device,
determining communications mode for nodes, wherein if flight status is takeoff or landing the communications mode is disable all transmission, and if flight status is climb, cruise or descent the communications mode is utilize only short-range transmission,
sending commands to nodes to disable all transmission or utilize transmission in accordance with the determined communications mode.

According to an exemplary embodiment of the present invention the method comprises a method item of determining that communications mode is allow long-range transmission if flight status is not takeoff, landing, climb, cruise or descent.

As briefly reviewed hereinbefore, the utility of the different aspects of the present invention arises from a plurality of issues depending on each particular embodiment.

The expression “a number of” may herein refer to any positive integer starting from one (1). The expression “a plurality of” may refer to any positive integer starting from two (2), respectively.

The term “exemplary” refers herein to an example or example-like feature, not the sole or only preferable option.

Different embodiments of the present invention are also disclosed in the attached dependent claims.

### BRIEF DESCRIPTION OF THE RELATED DRAWINGS

Next, some exemplary embodiments of the present invention are reviewed more closely with reference to the attached drawings, wherein

FIG. 1 illustrates an arrangement and some associated aspects thereof in accordance with an embodiment of the present invention.

FIG. 2 illustrates an arrangement and some associated aspects thereof in accordance with an embodiment of the present invention.

FIG. 3 illustrates a block diagram of the device in accordance with an embodiment of the present invention.

FIG. 4 illustrates a block diagram of a tracking sensor node in accordance with an embodiment of the present invention.

FIG. 5 illustrates a flow chart of a method in accordance with an embodiment of the present invention.

### DETAILED DESCRIPTION OF THE EMBODIMENTS

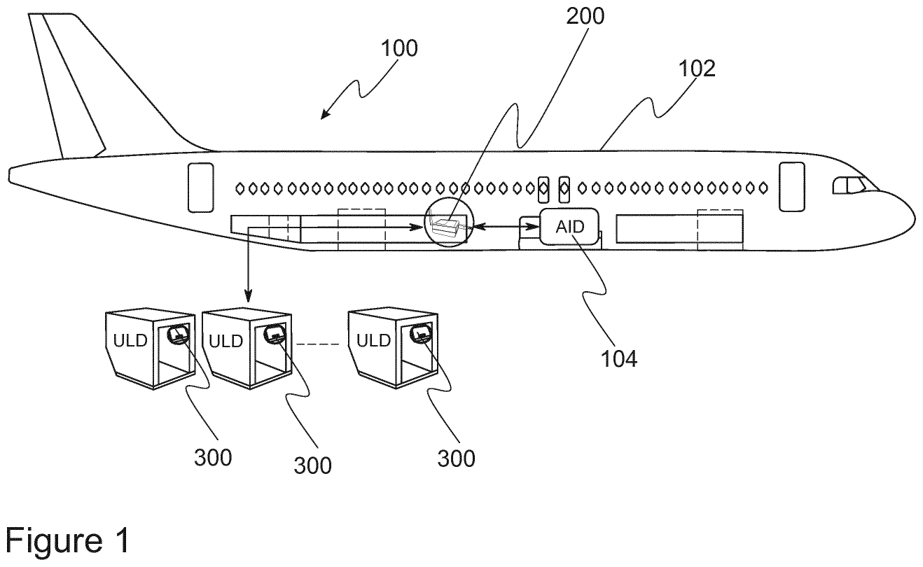

FIG. 1 illustrates an arrangement (100) and some associated aspects thereof in accordance with an embodiment of the present invention. The arrangement (100) comprises a gateway device (200) and tracking sensor nodes (300) situated in an aircraft (102). The arrangement (100) may be e.g. applied to track the temperature of the unit-load devices (ULDs) of the aircraft during transit.

The gateway device (200) is connected to the aircraft interface device (AID) (104), or such aircraft system interface device or software, and further connects or at least sends wireless signals towards the nodes (300), which nodes (300) are arranged to monitor the preferred parameter inside or outside the ULD or other cargo unit. The gateway device (200) may be connected to the AID (204) via Universal Serial Bus (USB) or such connection. The nodes (300) may be situated in a scattered manner in the aircraft (102) and hence they are arranged to at least receive signals wirelessly from the gateway device (200). The gateway device (200) may hence be arranged in a fixed location in the aircraft (102) whereas the tracking sensor nodes (300) may move in and out of the aircraft when the ULDs or other cargo with sensor nodes (300) attached thereof are loaded in and unloaded from the aircraft.

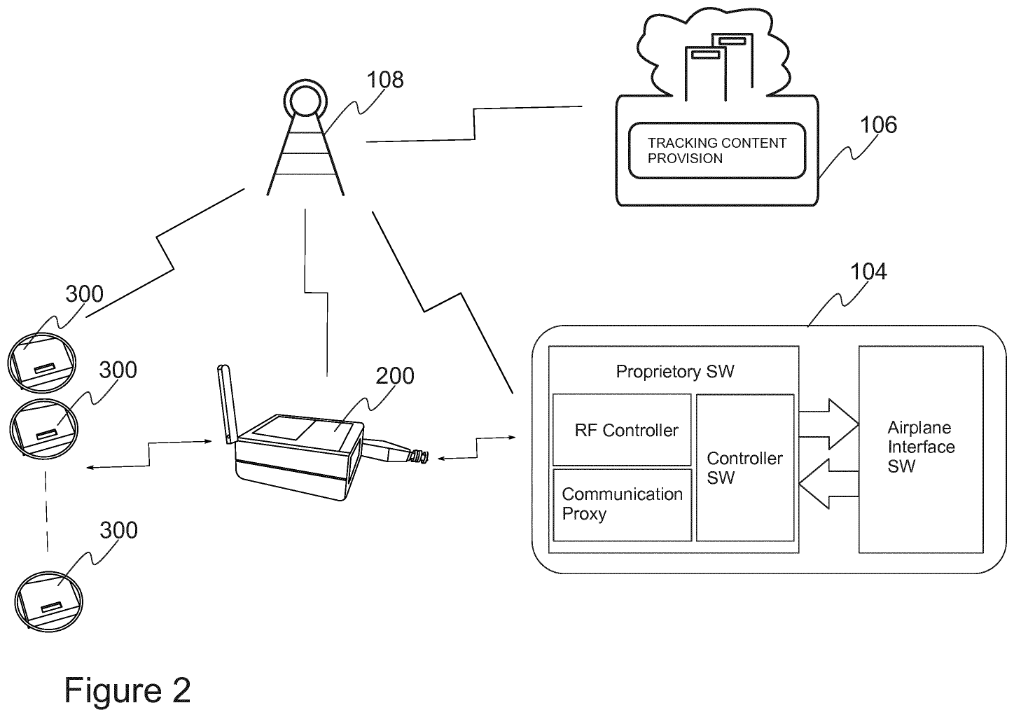

FIG. 2 illustrates another view of the arrangement (100) and some associated aspects thereof in accordance with an embodiment of the present invention.

The nodes (300) are connected to the gateway device (200) via wireless short-range communications means, such as on a 2.4 GHz band. The gateway device (200) is further connected to the AID (104) via USB or such means because the gateway device (200) may be arranged at a fixed location in the aircraft (102). The gateway device (200) communicates with the AID (102), wherein a proprietary software and an AID software are situated. The proprietary software preferably comprises an RF controller, a communication proxy and a control software to communicate with the AID software of the aircraft (102). The proprietary software is used to connect the gateway device (200) with the AID software so that the gateway device (200) may obtain information of the flight status.

The arrangement (100) may further comprise a remote server arrangement or cloud computing means for collecting tracking sensor data. The processing of data may utilize Edge computing means and/or the data may be processed at the cloud. Part of the tracking sensor data may be processed at the gateway device (200) or at the tracking sensor nodes (300).

The remote server or cloud server (106) may comprise at least means for processing, storing and provisioning of data. The data may be provided via a mobile app or web application provided on a user device. For example, sensor data from the ULDs and location of the ULDs and/or the gateway pertaining to the ULDs and an aircraft (102) may be monitored remotely via or from the remote server or cloud. At least parts of the arrangement software may be also controlled and/or updated remotely from the remote server or cloud.

The tracking sensor nodes may be arranged to utilize global IoT frequencies, such as IoT frequencies for communications outside the aircraft (102). These global IoT frequencies include e.g. NB-IoT, LTE Cat-M1 and 2G/3G/4G/5G communication means. The tracking sensor nodes (300) may operate and communicate with a base station (108), such as a low-power wide-area network (LPWAN) base station or cellular network base station, when they are not detecting a gateway device (200) beacon signal pertaining to utilization instructions to use different means of communications, which would be detected if the tracking sensor nodes (300) where in the vicinity of the gateway device (200) in an aircraft (102).

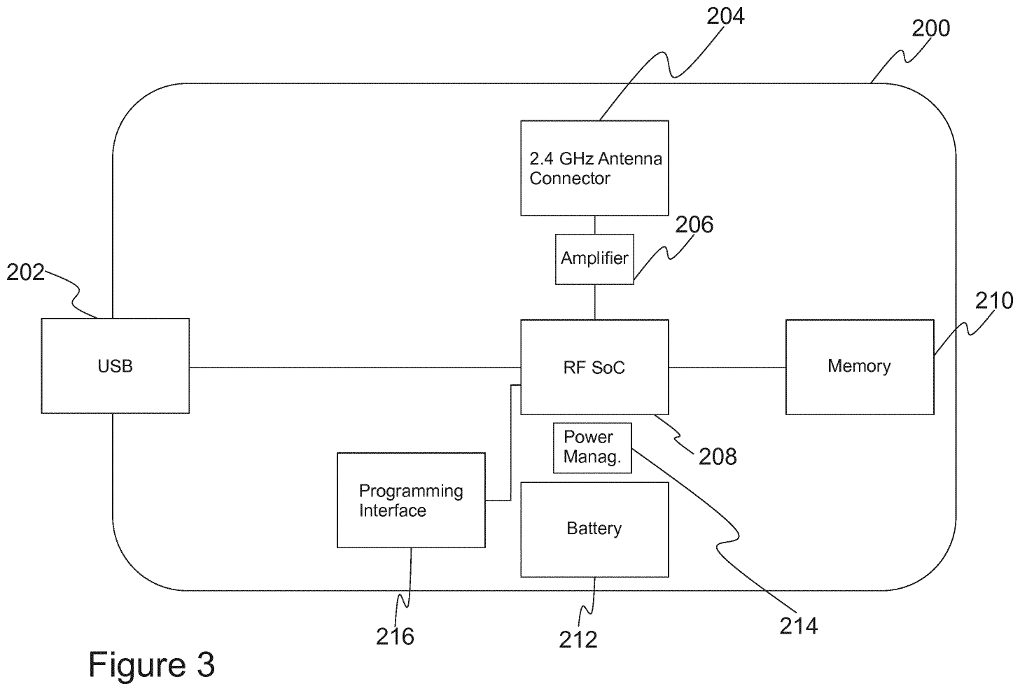

FIG. 3 illustrates a block diagram of the gateway device (200) in accordance with an embodiment of the present invention.

The gateway device (200) may be connected to the AID (104) via a USB (202) to receive flight status information from the AID (104). The received flight status information may include that the aircraft (102) is in a flight status, such as takeoff, landing, climb, cruise or descent phase.

The gateway device (200) further comprises at least wireless UHF short-range transmission means and preferably also receiving means, such as IEEE 802.11, IEEE 802.15.1 and/or such ISM/SRD band communication means for at least connecting with wireless nodes and optionally also for receiving tracking data from the tracking sensor nodes (300). The gateway device (200) may e.g. comprise 2.4 GHz antenna connector (204) with an amplifier (206) and a RF SoC (System on a Chip) (208) for facilitating gateway transceiver and other component or circuit control. The wireless transmission frequency and mode is determined in accordance of the received flight status information from the AID (104), which wireless signal is then transmitted from the gateway device (200) on a preferred frequency and which information is further sent as a signal to the sensor tracking nodes (300) to determine their mode of transmission. For example, if the gateway device (200) receives information from the AID (104) that the aircraft (102) is taking off or landing the gateway device (200) sends the nodes a command to disable all wireless transmission. Further, if the gateway device (200) receives information from the AID (104) that the aircraft (102) flight status is climb, cruise or descent the gateway device (200) sends the nodes a command to utilize only short-range wireless transmission means. The nodes preferably do not turn off their receiving means so that commands from the gateway device (200) may be received.

The gateway device (200) may utilize broadband communications uplink with a remote server or cloud (106) when the flight status is not landing or takeoff. When the flight status is landing or takeoff preferably narrowband uplink is used to send data from the gateway device (200) to the remote server or cloud (106). The broadband and narrowband connections from the gateway device (200) are arranged via the AID (104). The data from the gateway device (200) may comprise measurement data from the tracking sensor nodes, alerts and other such data pertaining to the cargo and transit conditions. This way tracking sensor node (300) data and measurements from the ULD may be acquired to a remote system, such as an intelligent cargo tracking system, without any long-range network communications from the tracking sensors providing essentially real-time air cargo monitoring.

The gateway device (200) may further comprise a memory (210) for storing measurement data from the tracking sensor nodes, alerts and other such data pertaining to the cargo and transit conditions, and a battery (212) and power management means (214). The gateway device may also comprise a programming interface (216) connected to the RF SoC (208).

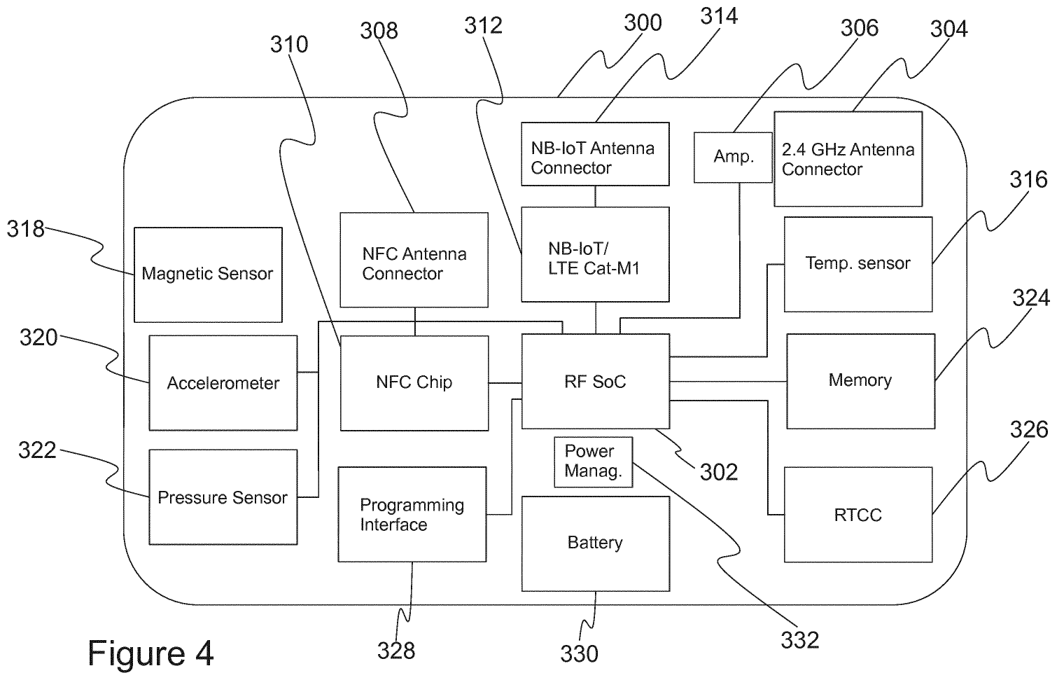

FIG. 4 illustrates a block diagram of a tracking sensor node (300) in accordance with an embodiment of the present invention.

The tracking sensor node (300) comprises at least an UHF transmitter, receiver and/or transceiver arranged to at least receive beacon signals from the gateway device (200) and to transmit signals to the gateway device (200) via short-range communications means. The UHF transmitter, receiver and/or transceiver may comprise one or more circuits and components pertaining to RFID, NFC, IEEE 802.11 a/b/g/n, IEEE 802.15.1, IEEE 802.15.4 and/or such ISM/RSD band communication techniques and may be provided with a RF SoC (302). For example, the RF SoC (302) may be connected to a 2.4 GHz antenna connector (304) with an amplifier (306) for facilitating a transceiver for short-range communications. The RF SoC (302) may be also connected to an NFC chip (308) and NFC antenna connector (310) for facilitating a transceiver for near-field communications. The UHF tracking node sensor (300) receiver and/or transceiver is preferably essentially constantly on so that the presence of a gateway device (200) is detected via the beacon signals received from the gateway device (200) and hence that the tracking node sensor (300) may connect with the gateway device (200) in the short-range sensor network zone.

The tracking sensor nodes (300) may comprise also long-range transmission means for transmitting data to a base station. The long-range transmission means may comprise one or more circuits, chips (312), antenna connectors (314), antennas and amplification means pertaining NB-IoT, LTE Cat-M1 and 2G/3G/4G/5G communication techniques.

The tracking sensor nodes (300) preferably comprise active tracking sensors, which include active sensing means of a number of preferred parameters for detecting the parameter with a sensor, and transmitting at least the sensor tracking data, such as measurement data, alerts, and/or metadata pertaining to measurements or the node functioning, to the gateway device (200) and/or to a base station wherefrom it may be delivered to a cloud database.

The tracking sensor nodes (300) may comprise one or more sensing means such as a number of ambient temperature sensors (316), magnetic sensors (318), accelerometers (320), pressure sensors (322) and gyroscope. Clearly, other such sensing means for detecting events or changes in the ambient or internal conditions of the tracking sensor node (300) may be also utilized. These sensors may be used to detect ambient pressure, temperature, changes in velocity and rotation of a ULD, which may be further used to determine and monitor the conditions of the ULD contents, i.e. the cargo that is transported. The sensors may be also utilized to detect the takeoff or other flight status changes at the node itself. This way the sensor nodes may detect at least the flight status takeoff and disable all transmissions until receiving a beacon signal from the gateway device pertaining to other instructions for transmission means. In some embodiments the nodes may detect also the landing of the aircraft, which may be used to resume short-range and/or long-range transmissions at the nodes. Clearly however in view of the preferred application and the parameter that is needed to be tracked also other sensors may be used.

The tracking sensor nodes (300) may comprise also other essential components or circuits such as a memory (324) for at least for collecting tracking sensor data, such as sensing means measurements. The memory (324) may be used to store the sensor data also for longer periods of time when data transmission from the node (300) is disabled or otherwise limited. The tracking sensor node (300) may also comprise a real-time clock (RTC) or a real-time clock and calendar (RTCC) circuit (326) e.g. for executing a sleep/wake up scheme. The tracking sensor node (300) may also comprise a programming interface (328) connected to the RF SoC (302) as well as typical battery and power management means (330, 332).

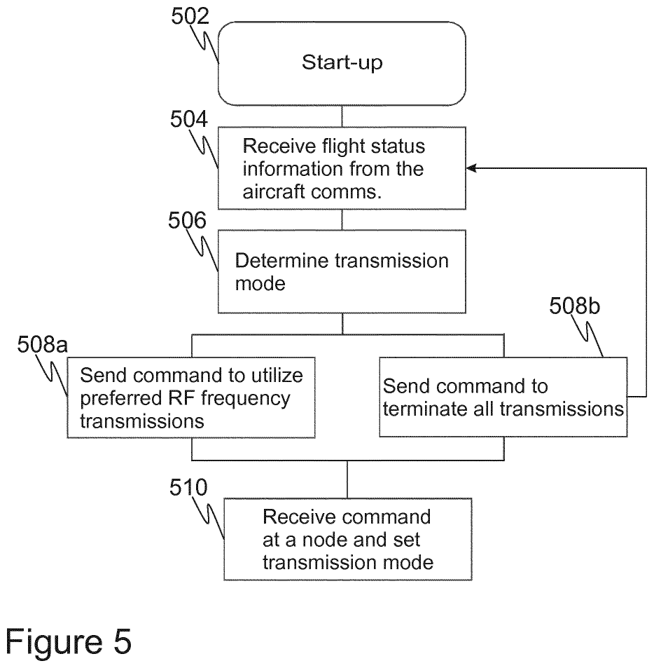

FIG. 5 illustrates a flow chart of a method in accordance with an embodiment of the present invention.

At start-up 502, an aircraft is for example loaded with ULDs containing tracking sensor nodes, which are arranged to track some predetermined condition parameters of the cargo in the ULD during the aircraft transport. The tracking sensor nodes may recognize the presence of a gateway device via beacon signals received from the gateway device or in some cases the nodes may recognize a flight status at the node itself and disable all wireless data transmission before receiving commands from the gateway device.

At 504, the gateway device receives flight status information from the AID.

At 506, the gateway device determines the short-range transmission mode for the nodes in accordance with the flight status. If the flight status is takeoff or landing all wireless transmissions of the nodes should be disabled. If the flight status is not takeoff or landing short-range wireless communication between the nodes and the gateway device should be allowed.

At 508a, the gateway has determined that the flight status is not takeoff or landing and command to utilize short-range wireless communication between the nodes and the gateway device is sent to the nodes.

At 508b, the gateway has determined that the flight status is takeoff or landing and command to disable all short-range wireless transmissions from the nodes is sent to the nodes.

At 510, at least one node receives the command from the gateway to set the transmission mode of the node either to allow short-range transmission of data or disable all data transmissions from the node.

The tracking sensors preferably collect measurement data as pre-determinedly arranged but transmitting the data inside the aircraft is only allowed with and as instructed by the gateway device whereas outside the aircraft the tracking sensor nodes may transmit and receive data via short-range and long-range means without the restrictions of the aircraft gateway device.

The arrangement allows for large-scale utilization and scalability for a number of nodes which may be monitored essentially real-time during the air transit. Also, the nodes may comprise essentially any kind of tracking or other wireless sensor for which transmission mode may be controlled during air travel.

The scope of the invention is determined by the attached claims together with the equivalents thereof. The skilled persons will again appreciate the fact that the disclosed embodiments were constructed for illustrative purposes only, and the innovative fulcrum reviewed herein will cover further embodiments, embodiment combinations, variations and equivalents that better suit each particular use case of the invention.

1. A gateway device for a sensor network comprising:
communication means to communicate with an aircraft interface device or other communication means provided by aircraft,
short-range wireless communication means for communicating with nodes via short range communication means,
wherein the gateway device is arranged to receive flight status information from the aircraft interface device and to facilitate control of nodes in accordance with the flight status, such as that the gateway sends the nodes a command to disable all wireless transmission when the aircraft status is takeoff or landing, and a command to utilize only short-range wireless transmission means when the aircraft status is climb, cruise or descent.

2. The device of claim 1 wherein the short-range communication means comprise IEEE 802.11, IEEE 802.15.1 and/or such ISM/SRD band communication means.

3. The device of claim 1 comprising broadband connection for sending measurement data received from the nodes via the aircraft interface device.

4. The device of claim 1 comprising narrowband connection for sending alerts associable with the gateway device or the nodes via the aircraft interface device.

5. An arrangement for controlling node communications in an aircraft:
a gateway device arranged to receive flight status information from an aircraft interface device system, the gateway further comprising means to facilitate wireless short-range communication,
at least one node comprising at least wireless short-range communication means,
the gateway device being arranged to facilitate control of the nodes in accordance with the flight status, such as that the gateway sends the nodes a command to disable all wireless transmission when the aircraft status is takeoff or landing, and a command to utilize only short-range wireless transmission means when the aircraft status is climb, cruise or descent.

6. The arrangement according to claim 5 wherein a node comprises long-range wireless communication means, which are controlled in accordance with the flight status.

7. The arrangement according to claim 5 wherein the nodes comprise ambient variable, movement and/or orientation detection means.

8. The arrangement according to claim 5 wherein the detection means are used to determine flight status at a node and wherein the node disables long-range wireless transmissions when takeoff, landing, climbing, cruising or descending flight status is determined.

9. The arrangement according to claim 5 wherein the gateway device facilitates command of the long-range wireless communication means of the nodes such that gateway sends the nodes a command to disable long-range wireless transmission when the aircraft status is take off, landing, climb, cruise or descent.

10. The arrangement according to claim 5 comprising a remote server or a cloud service for receiving data from the gateway device.

11. The arrangement according to claim 5 wherein the remote entity or cloud service and the gateway device are connected via a broadband or narrowband connection in accordance with the flight status.

12. The arrangement according to claim 5 wherein the remote entity or cloud service is arranged to for receiving alerts or data from the gateway device wherein the data is measurement data of an aircraft cargo.

13. The arrangement according to claim 5 wherein the nodes are arranged to send alerts or measurement data of an aircraft cargo to the remote entity or cloud service via long-range communication means.

14. A method for controlling nodes in a wireless sensor network comprising,
receiving flight status information from an aircraft interface device,
determining communications mode for nodes, wherein if takeoff or landing the communications mode is disable all transmission, and if flight status is climb, cruise or descent the communications mode is utilize only short-range transmission,
sending commands to nodes to disable all transmission or utilize transmission in accordance with the determined communications mode.

15. The method according to claim 14 wherein determining that communications mode is allow long-range transmission if flight status is not takeoff, landing, climb, cruise or descent.
